(19) United States
(12) Patent Application Publication
(10) Pub. No.: US 2026/0280312 A1
(43) Pub. Date: Sep. 17, 2026

(54) SYSTEMS AND METHODS OF ADAPTIVE DISPATCH AND DC BALANCING IN BATTERY ENERGY STORAGE SYSTEMS

(71) Applicant: FLUENCE ENERGY, LLC, Arlington, VA (US)

(72) Inventors: Mohamamdhassan Abdollahi Sofla, Raleigh, NC (US); Isaiah Dallas Jefferson, Jr., Mitchellville, MD (US)

(73) Assignee: FLUENCE ENERGY, LLC, Arlington, VA (US)

(21) Appl. No.: 18/873,082

(22) PCT Filed: Sep. 26, 2024
(86) PCT No.: PCT/US2024/048570

§ 371 Date: Dec. 9, 2024

Related U.S. Application Data
(60) Provisional application No. 63/541,533, filed on Sep. 29, 2023.

(51) Int. Cl. H02J 7/56; H01M 10/42; H01M 50/251; H02J 7/04; H02J 7/44; H02J 7/82; H02J 7/90

(52) U.S. Cl. CPC H02J 7/56; H01M 10/425; H01M 50/251; H02J 7/04; H02J 7/44; H02J 7/82; H02J 7/933; H01M 2010/4271; H01M 2220/10; H02J 2207/20

(57) ABSTRACT

An energy storage system includes a plurality of energy storage nodes. The energy storage nodes include a battery storage element and a control subsystem to receive battery data from the battery storage element. The energy storage system further includes a power conversion system (PCS); and a control system coupled to the energy storage nodes and configured to receive or store a required power flow. The control subsystem, the control system, or both are configured to determine a state of charge about one or more of the energy storage nodes from the battery data. The control system is configured to dispatch the required power flow across the plurality of energy storage nodes based on a DC link balancing algorithm that is activated in response to the state of charge exceeding a high SOC threshold or being below a low SOC threshold.

### CROSS-REFERENCE TO RELATED APPLICATIONS

This application claims priority to U.S. Provisional Patent Application No. 63/541,533 filed on Sep. 29, 2023, titled “SYSTEMS AND METHODS OF ADAPTIVE DISPATCH AND DC BALANCING IN BATTERY ENERGY STORAGE SYSTEMS,” the entire disclosure of which is incorporated by reference herein.

### TECHNICAL FIELD

The present subject matter relates to an energy storage system that includes a plurality of energy storage nodes. The present subject matter also encompasses controlling the dispatch of an energy storage node using an adaptive dispatch based on state of charge (SOC), a power command, and DC link (DC bus) balancing.

### BACKGROUND

An energy storage system, such as a battery energy storage system (BESS), can be set up in a distributed manner to satisfy safety and economical concerns. The energy storage system often includes associated components, such as many energy storage nodes that each include one or more enclosures that houses many batteries inside, and power conversion systems. Typically, the energy storage system includes a control system that monitors the energy storage nodes.

Current state of the art control systems control dispatch of an energy storage node based on the state of charge (SOC). Typically, the state of charge is determined by a battery management system (BMS) provided by a vendor. For example, the SOC can be determined by Coulomb counting and the BMS can provide a number from 0-100% as to whether a battery is full or empty. Unfortunately, existing control systems may fail to satisfy a dispatch to charge or discharge the energy storage node in edge case conditions based on an inaccurate picture from looking at the SOC alone. Consequently, existing energy storage systems may fail to charge the energy storage node when there is power storage capacity remaining and fail to discharge the energy storage node when there is stored power available.

A control system is needed to adaptively dispatch the energy storage nodes based on the SOC, the power command, and DC link (DC bus) balancing to optimize efficiency and performance of the BESS.

### SUMMARY

In a first example, an energy storage system 101 includes a plurality of energy storage nodes 105A-N. The plurality of energy storage nodes 105A-N include a battery storage element 106 and a control subsystem 110 to receive battery data 111A-N from the battery storage element 106. The energy storage system 101 further includes a power conversion system (PCS) 104; and a control system 115 coupled to the plurality of energy storage nodes 105A-N and configured to receive or store a required power flow 112. The control subsystem 110, the control system 115, or both are configured to determine a state of charge (SOC) 116A about one or more of the energy storage nodes 105A-N from the battery data 111A-N. The control system 115 is configured to dispatch the required power flow 112 across the plurality of energy storage nodes 105A-N based on a DC link balancing algorithm 190 that is activated in response to the state of charge 116A exceeding a high SOC threshold 181 or being below a low SOC threshold 182.

In a second example, a non-transitory computer-readable medium 313, 353 includes adaptive dispatch programming 330A-B. Execution of the adaptive dispatch programming 330A-B by one or more processors 312, 352 configures one or more controllers 110, 115, 170-173 to receive or store a required power flow 112 for an electrical application 103. Execution of the adaptive dispatch programming 330A-B by the one or more processors 312, 352 configures the one or more controllers 110, 115, 170-173 to determine a state of charge (SOC) 116A about one or more of the energy storage nodes 105A-N from the battery data 111A-N. Execution of the adaptive dispatch programming 330A-B by the one or more processors 312, 352 configures the one or more controllers 110, 115, 170-173 to dispatch the required power flow 112 across the plurality of energy storage nodes 105A-N based on a DC link balancing algorithm 190 that is activated in response to the state of charge 116A exceeding a high SOC threshold 181 or being below a low SOC threshold 182. For example, a kW command is provided to a power inverter 205 of the PCS 104 and the inverter 205 requests current on the DC bus 225 of a first energy storage node 105A.

In a third example, a method 600 includes receiving or storing a required power flow 112 for an electrical application 103. The method further includes determining a state of charge (SOC) 116A about one or more of the energy storage nodes 105A-N from the battery data 111A-N. The method further includes dispatching the required power flow 112 across the plurality of energy storage nodes 105A-N based on a DC link balancing algorithm 190 that is activated in response to the state of charge 116A exceeding a high SOC threshold 181 or being below a low SOC threshold 182.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations, by way of example only, not by way of limitations. In the figures, like reference numerals refer to the same or similar elements.

FIG. 1A depicts a system that includes an energy storage system, energy system, and an electrical application.

FIG. 1B depicts a battery array, an array controller, and core controllers of an example architecture of a control system of FIG. 1A.

FIG. 1C depicts the array controller, the core controllers, node controllers, and enclosure controllers in the example architecture of the control system of FIGS. 1A-B.

FIG. 2A illustrates a first energy storage node of a plurality of energy storage nodes of the energy storage system of FIGS. 1A-C coupled to the electrical application.

FIG. 2B illustrates a first energy storage node that includes a plurality of battery cubes and a plurality of power conversion systems coupled to a DC link (DC bus).

FIG. 3A is a high-level functional block diagram of the energy storage system of FIG. 1A that depicts components of the control system and a control subsystem for adaptive dispatch of the energy storage nodes.

FIG. 3B is another high-level functional block diagram of the energy storage system of FIGS. 1B-C that depicts components of the control system with various controllers for adaptive dispatch of the energy storage nodes.

FIG. 4A is an adaptive dispatch protocol for the energy storage system of FIG. 1A that is implemented by the control system, the control subsystem, and the plurality of energy storage nodes.

FIG. 4B is an adaptive dispatch protocol for the energy storage system of FIGS. 1B-C that is implemented by the various controllers of the control system and the plurality of energy storage nodes.

FIG. 5 is a cutaway view of the first energy storage node of the plurality of energy storage nodes and shows details of a plurality of battery storage elements.

FIG. 6 is a flowchart of a method that can be implemented for adaptive dispatch of the energy storage system.

FIG. 7 is a graph of two curves of the DC link voltage and state of charge showing two A2 areas (e.g., regions) in which the DC link balancing algorithm is activated by adaptive dispatch programming.

FIG. 8 is a block diagram of SOC-DC link balancing control of adaptive dispatch programming showing the DC link balancing algorithm.

FIG. 9 is a flowchart of the DC link balancing control algorithm of the adaptive dispatch programming.

FIG. 10 is a line graph of an example relationship between a pre-defined threshold voltage and the DC link voltage between energy storage nodes diverging which can cause the DC link balancing algorithm to be further activated.

### PARTS LISTING

100 System
101 Energy Storage System
102 Energy System
103 Electrical Application
104, 104A-N Power Conversion Systems
105A-N Energy Storage Nodes
106, 106A-N Battery Storage Elements
107, 107A-N Power Conversion Subsystems
108 Transformer
109 Energy Source
110 Control Subsystem
111A-N Battery Data
112 Required Power Flow
115 Control System
116A-N Battery States
116A State of Charge (SOC)
120 Physical Space
125 Power Bus
150 Battery Array
151A-N Battery Cores
170 Array Controller
171, 171A-N Node Controllers
172, 172A-N Core Controllers
173, 173A-N Enclosure Controllers
174 Market Dispatch Unit Controller
181 High SOC Threshold
182 Low SOC Threshold
183, 183A-N Power Commands
184 Stored Power
185 Power Storage Capacity
190 DC Link Balancing Algorithm
191 DC Link Voltage
192 Pre-Defined Threshold Voltage
205 Power Inverter
210 Rectifier
215 DC-DC Converter
225 DC Link (DC Bus)
230, 230A-N Battery Cubes
305, 305A-N Network
311, 351 Network Communication Interface
312, 352 Processor
313, 353 Memory
315A-N Sensors
330, 330A-B Adaptive Dispatch Programming
370A-N Environmental Sensors
375A-N Battery Sensors
400 Adaptive Dispatch Protocol
500 Enclosure
600 Method
700 SOC Voltage Curve
800 SOC-DC Link Balancing Control
900 Block Diagram
1000 Line Graph

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

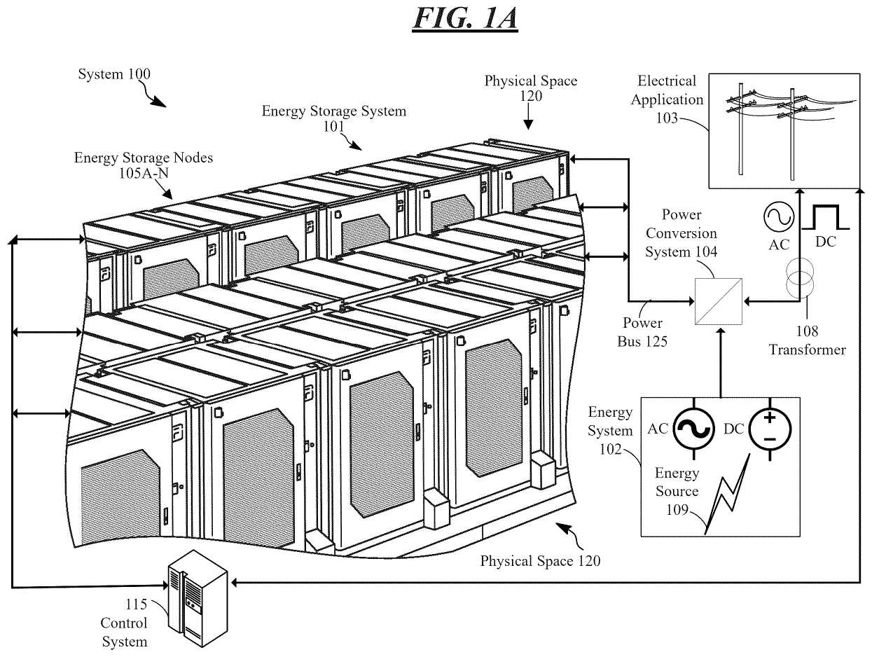

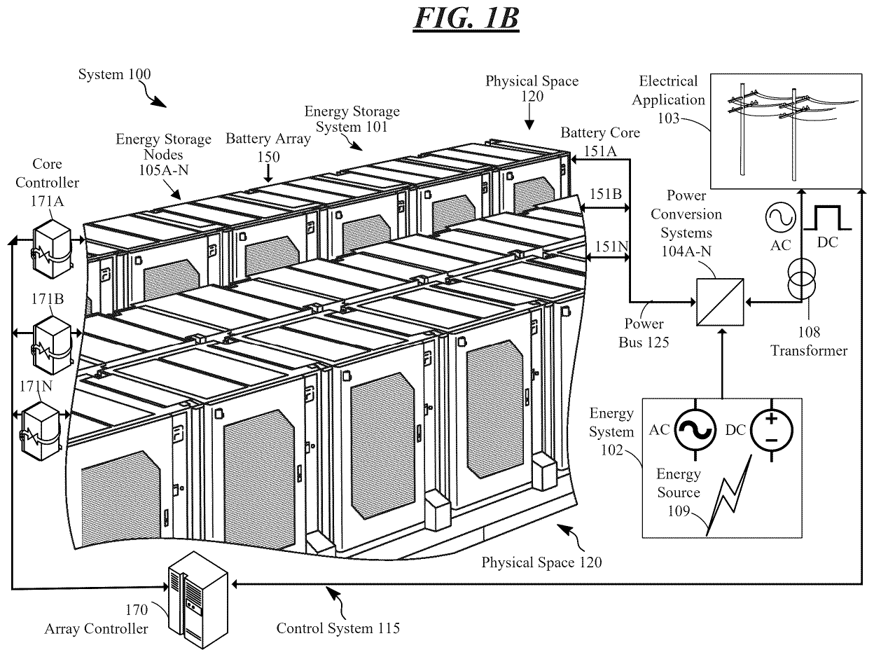

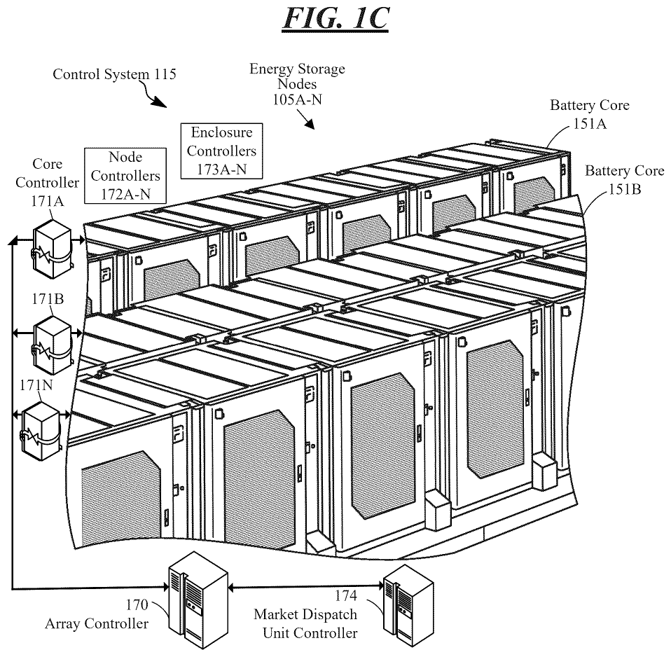

Unless otherwise indicated, any embodiment can be combined with any other embodiment. In particular, FIGS. 1A-10 and the associated text are all combinable with each other.

The term “coupled” as used herein refers to any logical, physical, electrical, or optical connection, link or the like by which electricity, power, signals, or light produced or supplied by one system element are imparted to another coupled element. Unless described otherwise, coupled elements or devices are not necessarily directly connected to one another and may be separated by intermediate components, elements, or communication media that may modify, manipulate or carry the electricity, power, signals, or light.

The orientations of the system 100, energy storage system 101, energy storage nodes 105A-N, associated components, and/or any complete devices, incorporating battery storage elements 106A-N, such as batteries, such as shown in any of the drawings, are given by way of example only, for illustration and discussion purposes. In operation for a particular energy storage application, an energy storage node 105A-N may be oriented in any other direction suitable to the particular application of the energy storage system 101, for example upright, sideways, or any other orientation. Also, to the extent used herein, any directional term, such as left, right, front, rear, back, end, up, down, upper, lower, top, bottom, and side, are used by way of example only, and are not limiting as to direction or orientation of any energy storage system 101 or energy storage nodes 105A-N; or component of an energy storage system 101 or energy storage nodes 105A-N constructed as otherwise described herein.

Unless otherwise indicated, any coupled electrical components can be linked in series or in parallel. In the case of energy storage nodes 105A-N or battery storage elements 106A-N, the components may be linked in series, in parallel, or a combination thereof depending upon a state of a switch or a submodule.

Reference now is made in detail to the examples illustrated in the accompanying drawings and discussed below.

FIG. 1A depicts a system 100 that includes an energy storage system 101, energy system 102, and an electrical application 103. FIG. 1B depicts a battery array 150, an array controller 170, and core controllers 171A-N of an example architecture of a control system 115 of FIG. 1A.

Referring to both FIGS. 1A-B, for example, the energy storage system 101 can be a battery energy storage system (BESS). The energy storage system 101 is coupled to the energy system 102 and the electrical application 103. Energy storage system 101 can include one or more power conversion systems (PCSs) 104A-N, a plurality of energy storage nodes 105A-N, an optional transformer 108, and a control system 115. Components of the energy storage system 101 can be located at a physical space 120 that is outdoors or indoors, for example, inside of a building, a container, or other structure.

Energy storage system 101 comprises a battery array 150 including a plurality of battery cores 151A-N including a first set of battery cores 151A-C and a second set of battery cores 151D-F. Each of the battery cores 151A-N include at least one power conversion system 104A-N. In an example, there can be one PCS 104 and one transformer 108 per battery core 151A-N (at the battery core level).

As described in further detail below, energy storage system 101 can include a control system 115 that includes one or more controllers 170-174, such as an array controller 170, core controllers 171A-N, node controllers 172A-N, enclosure controllers 173A-N, and a market dispatch unit controller 174. The control system 115 is configured to control the battery cores 151A-N to dispatch a required power flow 112.

Power conversion systems 104A-N are coupled to the plurality of energy storage nodes 105A-N. The power conversion systems 104A-N are coupled to the energy system 102 and the electrical application 103 to provide a required power flow 112 to the electrical application 103 by discharging the plurality of energy storage nodes 105A-N or the required power flow 112 from the energy system 102 for charging the plurality of energy storage nodes 105A-N. The power conversion systems 104A-N can be coupled to an optional transformer 108. The optional transformer 108 can step up or step down the required power flow 112 to and from the electrical application 103, such as an AC voltage.

Energy system 102 can include any suitable system for producing electrical energy from an energy source 109. Energy system 102 can be a renewable energy system in which the energy source 109 can be replenished. Such a renewable energy source 109 can include solar power, wind power, geothermal power, biomass, and hydroelectric power. For example, the renewable energy system 102 can be implemented as an array of photovoltaic modules. The photovoltaic (PV) modules can include crystalline silicon, amorphous silicon, copper indium gallium selenide (CIGS) thin film, cadmium telluride (CdTe) thin film, and concentrating photovoltaic which uses lenses and curved mirrors to focus sunlight onto small, but highly efficient, multi-junction solar cells. In another example, the energy system 102 can include wind turbines or gas turbines. In some examples, the energy system 102 can be a non-renewable energy system in which the energy source 109 includes a non-renewable energy source, such as a fossil fuel.

Electrical application 103 can include an electrical grid, such as a power grid, or a smaller local load, such as a backup power system, for a facility such as a hospital, manufacturing site, residential home, or other suitable facility. The electrical application 103 may deliver AC or DC power for on-grid or off-grid applications, including commercial, industrial, or residential applications. The electrical application 103 may deliver power to buildings, electric vehicle charging stations, etc., including a variety of electrical loads that consume AC or DC electric power. The electrical application 103 can be a front-of-the-meter system that is owned or operated by a utility company or a behind-the-meter system that directly supplies buildings and homes with electricity.

Energy source 109 can be a renewable energy source, such as solar power and wind power, which can be intermittent and less reliable compared to fossil fuels. To improve resiliency, energy storage system 101 can store energy from the energy system 102 when the production from the energy source 109 is high. Later on, the energy storage system 101 can dispatch the energy to the electrical application 103 when demand is high or production from the energy source 109 is not keeping up with demand. Moreover, events may occur when a connected load or an operating demand load of the electrical application 103 is excessive or there is electrical grid instability, such as during extreme weather. By storing energy from the energy source 109 and then dispatching the energy during such events, the energy storage system 101 can continue to dispatch a required power flow 112 of the electrical application 103.

Energy storage nodes 105A-N include battery storage elements 106A-N. The battery storage elements 106A-N can be: (1) a single battery cell; (2) a cell grouping, including several battery cells in parallel configuration; (3) a battery submodule or module, including several battery cells in parallel and serial configuration; (4) a battery string, including several battery modules in series; (5) a battery bank, including several battery strings in parallel; (6) other known energy storage elements; and/or (7) a combination thereof. For example, the battery storage elements 106A-N can include a plurality of batteries of any existing or future reusable battery technology, including, but not limited to lithium ion, flow batteries, or mechanical storage, such as flywheel energy storage, compressed air energy storage, pumped-storage hydroelectricity, gravitational potential energy, or a hydraulic accumulator.

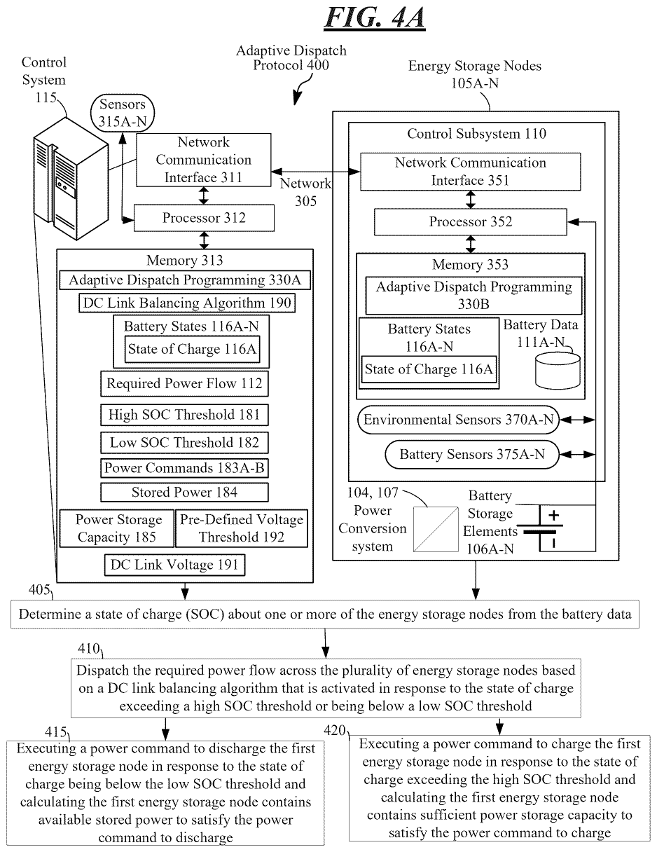

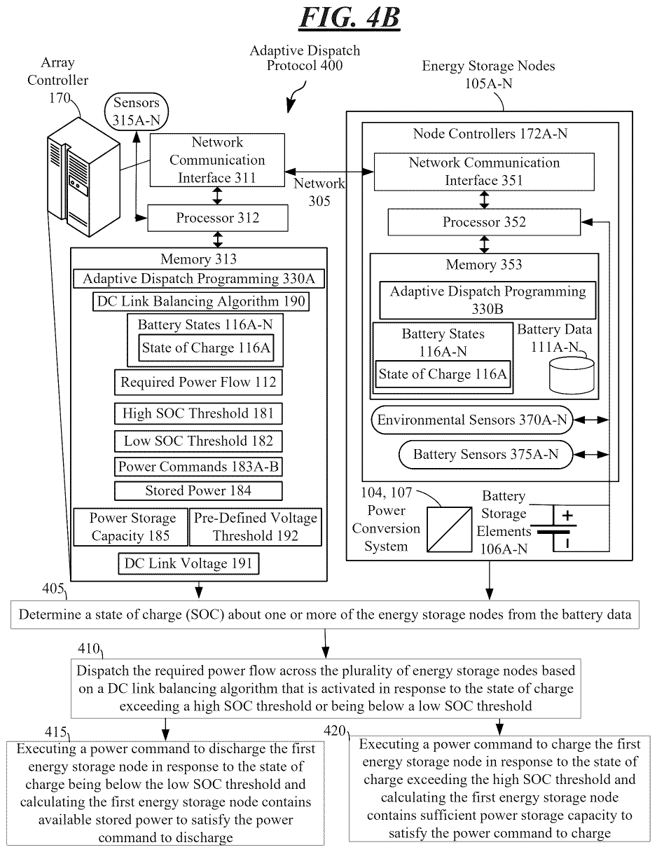

Control system 115 implements an adaptive dispatch protocol 400 (see FIGS. 4A-B) which can be implemented as a split bus power conversion system (PCS) adaptive dispatch control with an adaptive DC balancing feature. The adaptive dispatch protocol 400 ensures that the state of charge 116A of energy storage nodes 105A-N are balanced with the desired speed and accuracy; and the adaptive balancing control can ensure that the DC links 225 of the split bus PCS are balanced. The SOC balancing control can be adaptive which can mean based on an SOC imbalance situation, it can smoothly control the power command to ensure that the SOCs are balanced as fast and smooth as possible. In this design, the adaptive dispatches are controlled proportionally to the SOCs. The power of the proportional dispatch is controlled based on the SOC imbalance levels. Furthermore, a DC link balancing algorithm 190 is added to the adaptive dispatch protocol 400 to balance a DC bus 225. The DC link balancing algorithm 190 can be activated in two alternative scenarios. First, if a very high SOC threshold 181 or a very low SOC threshold 182 is hit. Second, if the DC link voltages 191 between energy nodes storage nodes 105A-N started to diverge over a pre-defined threshold voltage 192. The diverging over the pre-defined threshold voltage 192 can include determining battery cells that are outliers in the low SOC threshold 182 and determining if a delta is greater than a standard delta. The high SOC threshold 181 and the low SOC threshold 182 are magnitudes or intensities of the state of charge 116A and can cause activation of the DC link balancing algorithm 190. For example, the high SOC threshold 181 may be approximately 90%, approximately 95%, or approximately 98%; and the low SOC threshold 182 may be approximately 2%, approximately 5% or approximately 10%.

The DC link balancing algorithm 190 works the same way as the SOC balancing. The DC link balancing algorithm can be adaptive and proportionate to the DC links of the power inverter 205 modules of a split bus architecture of a PCS 104. Conventional SOC balancing dispatch algorithms had a problem of being too aggressive or too weak in responding to SOC unbalanced situations. This could be a major problem as it may exacerbate DC link imbalance between the power inverter 205 modules of the PCS 104. Furthermore, the DC link 225 of power inverter 205 modules of a PCS 104 can diverge due to various hardware and firmware reasons. This can accelerate and amplify the circulating currents in PCS 104 and eventually result in failures.

FIG. 1C depicts the array controller 170, the core controllers 171A-N, node controllers 172A-N, and enclosure controllers 173A-N in the example architecture of the control system 115 of FIGS. 1A-B. In the example, each of the energy storage nodes 105A-N can be a collection of one or more battery cubes 230A-N and every battery cube 230A-N includes an enclosure controller 173. A node controller 172 is the lowest controllable element of a battery core 151 for an energy storage node 105A-N and controls an individual energy storage node 105. A core controller 171 is the next higher level, which controls a subset of the energy storage nodes 105A-N, where each core represents branches of components of the energy storage system 101. The core controller 171 is a logical controller and can represent a transformer 108 that stands between the PCS 104 and the rest of the plant. Core controller 171 is an aggregator of different node controllers 172A-N and propagates the commands from the array controller 170 to the node controllers 172A-N.

Array controller 170 is higher than the core controllers 171A-N and controls the overall energy storage system 101. The software for the array controller level can be installed at a customer installation site and can execute at the installation site. The array controller 170 can be a local decentralized service that runs onsite in real time.

A market dispatch unit controller 174 is a network wide controller and sits on top of the array controller 170 and looks at specific market requirements. The market dispatch unit controller 174 sets dispatch setpoints in terms of active and reactive power to the array controller 170 which deals with the energy storage system 101.

A battery core 151 can have multiple node controllers 172A-N depending on the number of energy storage nodes 105A-N and bus architecture of the battery core 151. In an example, if the PCS 104 is used as a single bus element, then there may be only one node controller 172 behind a core controller 171 for a single energy storage node 105A and only one PCS 104 per energy storage node 105A. But if the PCS 104 is used with multiple DC connections in a split bus architecture where a plurality of energy storage nodes 105A-D (e.g., four) are connected to the bus, there can be a plurality of energy storage nodes 105A-D on the bus and only one PCS 104 for all of the plurality of energy storage nodes 105A-D.

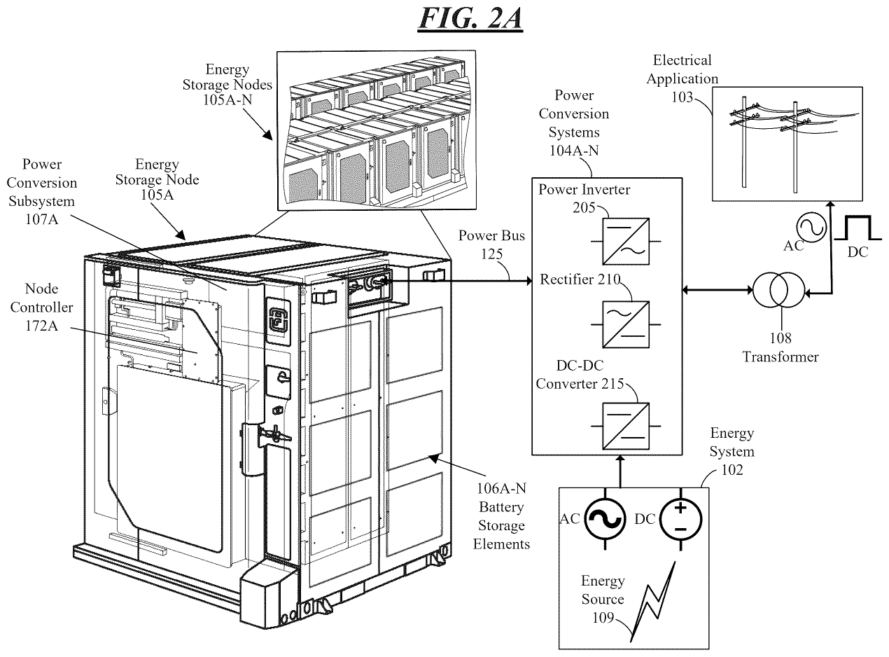

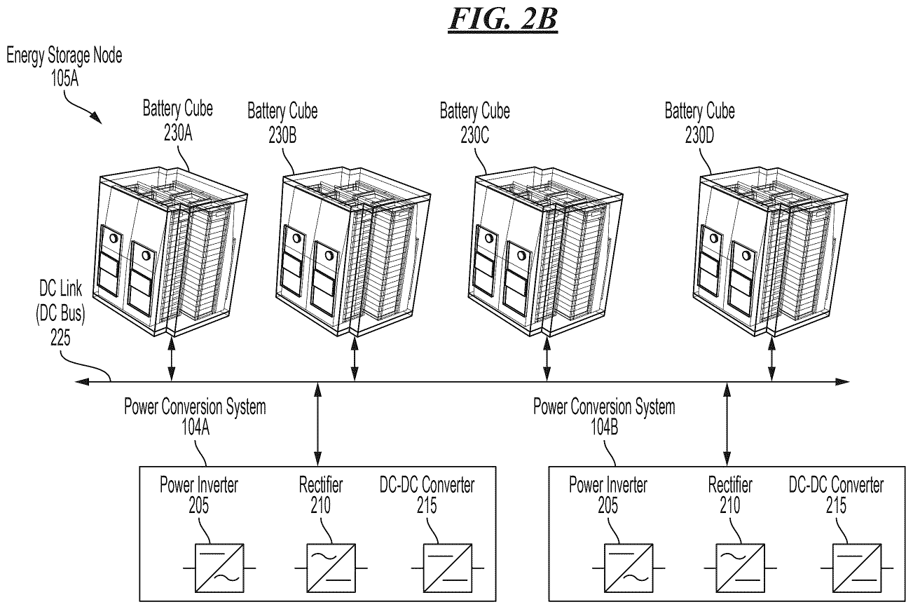

FIG. 2A illustrates a first energy storage node 105A of the plurality of energy storage nodes 105A-N of FIGS. 1A-C coupled to the electrical application 103. The first energy storage node 105A can include a single battery cube 230A (as in the case of FIG. 2A) or a plurality of battery cubes 230A-D (as in the case of FIG. 2B). Energy storage nodes 105A-N can include a battery storage element 106, a power conversion system 104 (or a power conversion subsystem 107), and a node controller 172 (or a control subsystem 110) to receive battery data 111A-N from the battery storage element 106, the power conversion subsystem 107 (or the power conversion system 104), or a combination thereof.

Power conversion system 104 or the power conversion subsystem 107 can include a power inverter 205, a rectifier 210, a DC-DC converter 215, other power conversion elements, or a combination thereof. Power inverter 205 can be configured to convert a DC source, such as from the battery storage elements 106A-N, into an AC waveform. Rectifier 210 can be configured to convert an AC source, such as from the energy system 102 or electrical application 103, into DC for the battery storage elements 106A-N. DC-DC converter 215 can be configured to convert a DC source, such as from the battery storage elements 106A-N, into a different DC source characteristic.

If the energy source 109 is wind power, then the power conversion system 104 can convert the AC electricity produced into DC power for storage in the plurality of energy storage nodes 105A-N via the rectifier 210. If the energy source 109 is solar power, then the power conversion system 104 can convert the DC electricity into a different voltage level via the DC-DC converter 215. The power inverter 205 can convert the required power flow 112 from the energy storage system 101 from DC power into AC power during dispatch to the electrical application 103. For example, the power inverter 205 can be configured to convert power on a power bus 125 (e.g., AC bus, DC bus, or both) for use by the electrical application 103. For example, the power inverter 205 converts DC power stored in the energy storage nodes 105A-N into AC power for consumption by electrical loads of the electrical application 103.

Power conversion subsystem 107 includes similar hardware and software as the more centralized power conversion system 104. Power conversion subsystem 107 can be distributed more locally to each of energy storage nodes 105A-N. The node controller 172 and the control subsystem 110 can be configured for local computation, processing, and control of the battery storage elements 106A-N and the power conversion subsystem 107. The control system 115 and the array controller 170 can be configured for more centralized computation, processing, and controls of the overall energy storage system 101, energy system 102, electrical application 103, and power conversion system 104. The various controllers 170-173 of the control system 115, including the array controller 170, core controllers 171A-N, node controllers 172A-N, and enclosure controllers 173A-N can include a single board computer, an application-specific integrated circuit (ASIC), microcontroller, digital signal processor (DSP), field-programmable gate array (FPGA), or a combination thereof.

FIG. 2B illustrates a first energy storage node 105A that includes a plurality of battery cubes 230A-N and a plurality of power conversion systems 104A-N coupled to a DC link (DC bus) 225. As shown, the first energy storage node 105A includes four battery cubes 230A-D and two power conversion systems 104A-B coupled to the DC link (DC bus) 225 in the example.

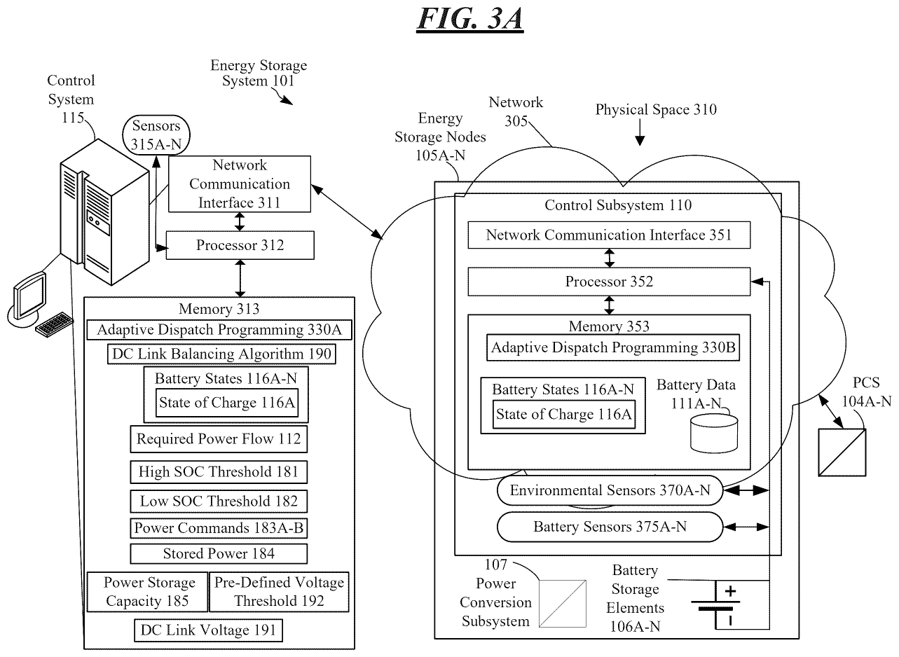

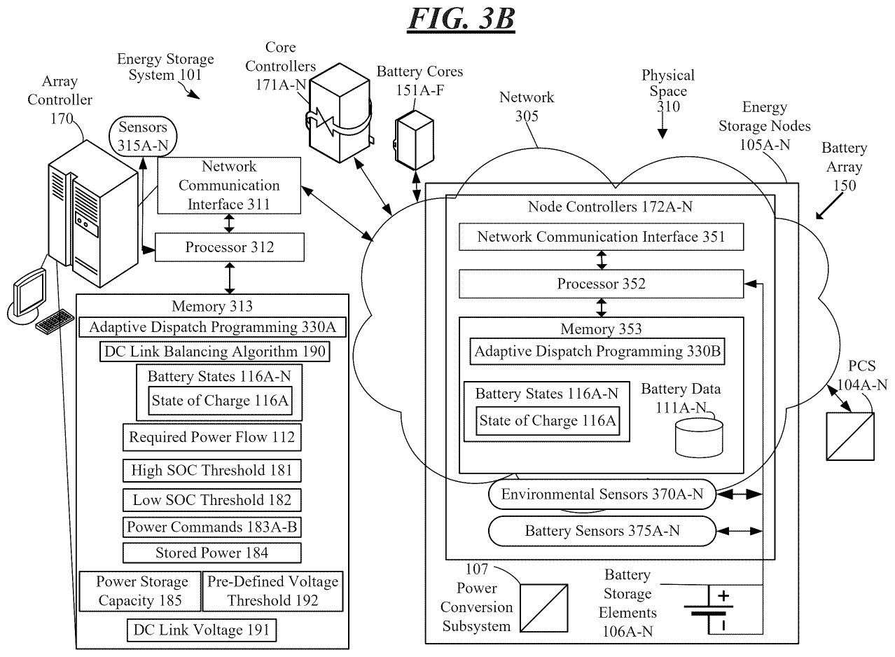

FIG. 3A is a high-level functional block diagram of the energy storage system 101 of FIG. 1A that depicts components of the control system 115 and the control subsystem 110 for adaptive dispatch of the energy storage nodes 105A-N. FIG. 3B is another high-level functional block diagram of the energy storage system of FIGS. 1B-C that depicts components of the control system 115 with various controllers 170-173 for adaptive dispatch of the energy storage nodes 105A-N.

Referring to FIGS. 3A-B, as shown, the plurality of energy storage nodes 105A-N include a battery storage element 106A-N; a power conversion subsystem 107; and a control subsystem 110 (FIG. 3A) or a node controller 172 (FIG. 3B) to receive battery data 111A-N from the battery storage element 106A-N, PCS data 157A-N from the power conversion subsystem 107, or a combination thereof. The control system 115 can be coupled to the energy storage nodes 105A-N and the PCS 104 and configured to receive battery data 111A-N from the battery storage element 106, PCS data 157A-N from the power conversion system 104 (or power conversion subsystem 107), or a combination thereof.

The control subsystem 110; control system 115, including the array controller 170, core controllers 171A-N, node controllers 172A-N, and enclosure controllers 173A-N; energy storage nodes 105A-N; electrical application 103; and other components of the system 100 can be in communication over a network 305 or one or more networks 305A-N. The networks 305A-N can be a local area network 305A, wide area network 305B, or a combination thereof. For example, the control system 115 can be coupled via a local area network 305A to the energy storage nodes 105A-N and the electrical application 103. Alternative or additionally, the control system 115 can be coupled via a wide area network 305B to the energy storage nodes 105A-N and electrical application 103. Or the control system 115 can be coupled via a combination of networks 305A-N, such as via a local area network 305A to components of the energy storage system 101, including the energy storage nodes 105A-N, and coupled via a wide area network 305B to the electrical application 103.

Control system 115 of FIG. 3A and array controller 170 of FIG. 3B include a network communication interface 311 configured for wired or wireless communication over the network 305. The control system 115 and the array controller 170 further include a memory 313, and a processor 312 coupled to the network communication interface 311 and the memory 313. As shown, the memory 313 of the control system 115 and the array controller 170 is configured to store adaptive dispatch programming 330A, a DC link balancing algorithm 190, battery data 111A-N, a required power flow 112, battery states 116A-N, a state of charge 116A, a high SOC threshold 181, a low SOC threshold 182, power commands 183A-B, a stored power 184, a power storage capacity 185, a DC link voltage 191, and a pre-defined voltage threshold 192. The control system 115 and the array controller 170 can also include sensors 315A-N coupled to the processor 312 to detect or monitor various system parameters, such as power, temperature, voltage, current, resistance, and/or impedance. For example, the sensors 315A-N can be coupled to the power bus 125 and the DC link (DC bus) 225.

Control system 115 and the array controller 170 are configured to receive or store a required power flow 112 for an electrical application 103. The required power flow 112 can include an active power (e.g., measured in kW or mW), a reactive power (e.g., measured in kVARs), or a total system power discharge or charge requirement. The required power flow 112 can be a power command for the electrical application 103 based on a customer or independent system operator request received over the network 305 from the electrical application 103, in which case the power command 183 is externally determined.

The power command for the electrical application 103 can be based on parameters in a customer or independent system operator request received over the network 305 from the electrical application 103. For example, the parameters can be to provide frequency regulation with a deadband and a slope of the response. The control system 115 can take the parameters and attempt to determine the power command, for example, based on satisfying the customer or independent system operator request for the electrical application 103.

Control system 115 can take the required power flow 112 needed for the electrical application 103, for example, as requested by a customer or software application and determine the optimal way to distribute the required power flow 112 across all of the energy storage nodes 105A-N. This optimization may be conducted in several manners, for example using traditional operational optimization techniques or machine-learning based techniques. The control system 115 can include one or more processors, controllers, or computing devices that can be configured to perform closed loop management of real and reactive power supplied to the electrical application 103.

Energy storage nodes 105A-N include a control subsystem 110 in FIG. 3A and a node controller 172 in FIG. 3B, battery storage elements 106A-N, and a power conversion subsystem 107 (or a power conversion system 104), which can reside on each individual energy storage node 105A-N. The control subsystem 110 and the node controller 172 of the energy storage nodes 105A-N include a network communication interface 351 configured for wired or wireless communication over the network 305. The control subsystem 110 and the node controller 172 further include a memory 353, and a processor 352 coupled to the network communication interface 351 and the memory 353. As shown, the memory 353 of the control subsystem 110 and the node controller 172 is configured to store adaptive dispatch programming 330B, battery data 111A-N, battery states 116A-N, and a state of charge 116A.

The control subsystem 110 and the node controller 172 further include environmental sensors 370A-N and battery sensors 375A-N coupled to the processor 352. Environmental sensors 370A-N can collect environmental condition data, for example, by measuring humidity and temperature inside of an enclosure 500 of the energy storage nodes 105A-N, such as one or more battery cubes 230A-N. Battery sensors 375A-N can include a voltage sensor 375A, a current sensor 375B, and a temperature sensor 375C to measure readings of battery data 111A-N, such as a voltage 111A, a current 111B, a temperature 111C, or other physical phenomena occurring within the battery storage elements 106A-N. The memory 353 can store the environmental condition data collected by the environmental sensors 370A-N and the battery data 111A-N measured by the battery sensors 375A-N.

The control subsystem 110 or the control system 115 is configured to determine at least one battery state 116A-N about one or more of the energy storage nodes 105A-N from the battery data 111A-N. The battery states 116A-N can be algorithmically determined estimates from battery data 111A-N, readings from the sensors 315A-N that monitor various system parameters on the power bus 125, DC link (DC bus) 225, or a combination thereof, for example. State estimating algorithms can take the measured readings of battery data 111A-N, including the voltage 111A, the current 111B, the temperature 111C, or a combination thereof as input parameters and estimate the battery states 116A-N based on the battery data 111A-N.

For example, a state of charge 116A is a state estimate derived from the voltage 111A and the current 111B readings. The state of charge 116A can be derived from the control system 115. Alternatively or additionally, at least one battery management system (BMS) or the node controller 172 can derive the state of charge 116A.

The control system 115 and the array controller 170 can manage power commands 183A-N to the control subsystem 110 and the node controller 172 respectively, to charge or discharge the plurality of energy storage nodes 105A-N based on the required power flow 112. For example, the control system 115 and the array controller 170 can send the power commands 183A-N based on the total required power flow 112 to the plurality of energy storage nodes 105A-N. Alternatively or additionally, the control subsystem 110 and the node controller 172 can issue the power commands 183A-N directly at the plurality of energy storage nodes 105A-N based on the required power flow 112.

FIG. 4A is an adaptive dispatch protocol 400 for the energy storage system 101 of FIG. 1A that is implemented by the control system 115, the control subsystem 110, and the and the plurality of energy storage nodes 105A-N. In the example of FIG. 4A, the adaptive dispatch protocol 400 is implemented in the adaptive dispatch programming 330A of the control system 115 and the adaptive dispatch programming 330B of the control subsystem 110.

FIG. 4B is an adaptive dispatch protocol 400 for the energy storage system 101 of FIGS. 1B-C that is implemented by the various controllers 170-173 of the control system 115 and the plurality of energy storage nodes 105A-N. In the example of FIG. 4B, the adaptive dispatch protocol 400 is implemented in the adaptive dispatch programming 330A of the array controller 170 and the adaptive dispatch programming 330B of the node controller 172.

Referring to both FIGS. 4A-B, execution of adaptive dispatch programming 330A stored in a memory 313 by a processor 312 of the control system 115 (e.g., array controller 170) configures the control system 115 (e.g., array controller 170) to implement blocks 405, 410, 415, and 420 described below. Execution of adaptive dispatch programming 330B stored in a memory 353 by a processor 352 of the control subsystem 110 (e.g., node controller 172) to implement block 405 described below. More generally, the execution of the adaptive dispatch programming 330A-B by one or more processors 312, 352 can configure one or more controllers 110, 115, 170-173 to implement blocks 405, 410, 415, and 420 below.

Beginning in block 405, the adaptive dispatch protocol 400 includes to determine a state of charge (SOC) 116A about one or more of the energy storage nodes 105A-N from the battery data 111A-N. The state of charge 116A can be determined for a first energy storage node 105A that includes a plurality of battery cubes 230A-N. The control subsystem 110 can include at least one battery management system (BMS).

The SOC 116A is determined for an entire energy storage node 105A-N (e.g., a first energy storage node 105A including all seven battery cubes 230A-G of all battery storage elements 106A-N behind the first energy storage node 105A). SOC calculations may look at voltage on the DC bus 225 over time. The SOC 116A is a calculated number of all battery cubes 230A-G put together on that first energy storage node 105A based on how much current is being put through and how much energy can get out. The SOC 116A is one parameter reading for an entire DC bus 225 for the first energy storage node 105A. However, the SOC 116A might not be accurate at the edge cases because of the battery chemistry and the energy storage system 101 is running at high power, which is not always accurate if the SOC is exceeding a high SOC threshold 181 or a low SOC threshold 182.

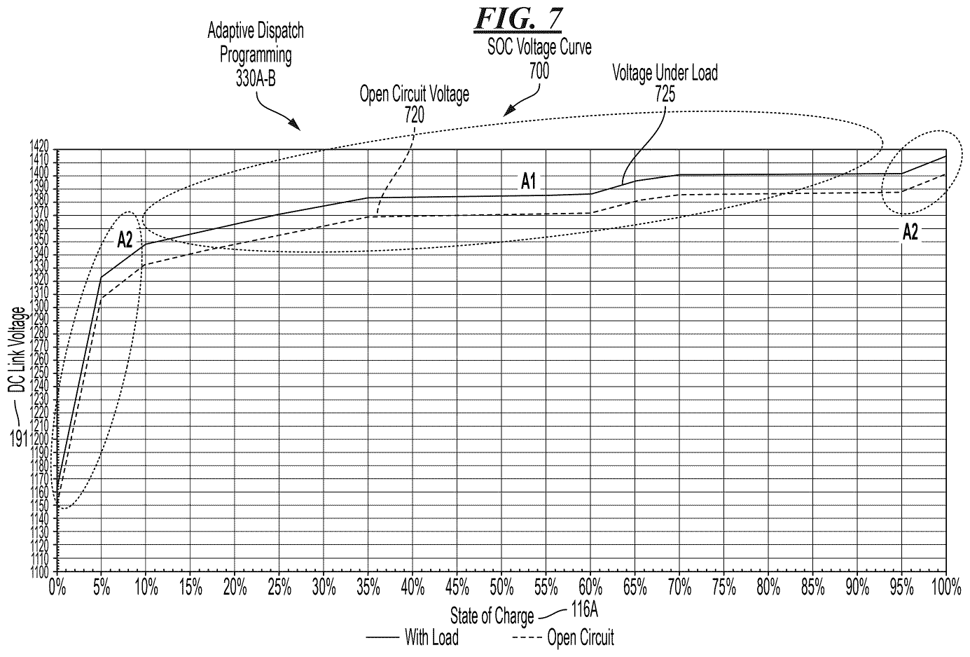

The adaptive dispatch protocol 400 addresses edge case conditions (regions A2 in in FIG. 7) in which the SOC 116A is not exactly accurate as provided by a battery management system (BMS) of the energy storage system 101. The adaptive dispatch protocol 400 balances the DC bus 225 in instances where the SOC 116A is very low or very high instead of depending on an inaccurate SOC calculation. In mid-range conditions (region A1 in FIG. 7), the SOC 116A being provided is typically accurate and conventional SOC balancing is used instead of the DC link balancing algorithm 190 of the adaptive dispatch programming 330A-B. Two SOC thresholds 181, 182 can be used to control a DC link balancing algorithm 190. There are two methods to proportionate the command based on the DC links. One method can be based on energy reflection by DC link voltage 191.

The SOC 116A provided by a battery management system, for example, can be based on Coulombe counting and be a number from 0-100% as to whether a first energy storage node 105A is full or empty. Typically, the SOC 116A is provided at the node level for all of the battery cubes 230A-N on that DC bus 225. Each battery rack of a battery cube 230 has a BMS and that information can be propagated to a system level BMS to determine the SOC 116A of all of the battery cubes 230A-N, as opposed to each individual battery cube 230 or each battery cell in the battery cube 230. A very low or very high SOC 116A reading is not necessarily accurate and there can be more energy available in a first energy storage node 105A. When the SOC 116A of the first energy storage node 105A is empty, a conventional control system would stop sending a power command 183A to discharge when the first energy storage node 105A has a very low SOC 116A. In this situation, however, the adaptive dispatch programming 330A-B can discharge the first energy storage node 105A because even though the SOC 116A indicates the first energy storage node 105A is too depleted, based on the DC link balancing algorithm 190, the first energy storage node 105A can be discharged a bit more without damaging the batteries.

Similarly, when the SOC 116A is of the first energy storage 105A is full at 100%, a conventional control system would stop sending a power command 183B to charge. But the first energy storage node 105A might not actually be full and at less 100%, such as 99%. In this situation, the adaptive dispatch programming 330A-B of the control system 115 can charge the first energy storage node 105A a bit more without harming the batteries.

Moving now to block 410, the adaptive dispatch protocol 400 further includes to dispatch the required power flow 112 across the plurality of energy storage nodes 105A-N based on a DC link balancing algorithm 190 that is activated in response to the state of charge 116A exceeding a high SOC threshold 181 or being below a low SOC threshold 182.

Block 410 can be understood by referring to FIG. 7. In region A1, the SOC 116A is accurate and the BMS vendor provided SOC calculation can be used. But in regions A2, the calculation of SOC 116A may not be very accurate and the adaptive dispatch programming 330A-B can do better by using a DC link balancing algorithm 190 to obtain as much energy out of the energy storage system 101 as possible. The DC link balancing algorithm 190 can be executed at the node controller 172 level. The core controller 171 might look at all of its energy storage nodes 105A-N and aggregate across the energy storage nodes 105A-N, but the chief concern may be at the node level.

For example, if the SOC 116A is between 93% and 100%, the SOC 116A is ignored and the DC link balancing algorithm 190 is activated to determine how much more energy can be added to a first energy storage node 105A during charging. Similarly, if the SOC 116A is 10% or lower, the SOC 116A is ignored and the DC link balancing algorithm 190 is activated to determine how much more energy can be provided from a first energy storage node 105A during discharging. The DC link balancing algorithm 190 can look at the DC link voltage 191 on the DC bus 225, what is the power command 183A-B (e.g., requested current on the DC bus 225). Based on that power command 183A-B (e.g., power requested) and DC link voltage 191 on the DC bus 225, the DC link balancing algorithm 190 can determine another three minutes of energy can be obtained from the first energy storage node 105A based on the rate of discharge in the power command 183A, for example. For example, the first energy storage node 105A may not be completely empty when the SOC 116A indicates as such if low power is requested in the power command 183A to discharge. But if the discharge requested in the power command 183A is at full power, there may be 0 minutes left because if running at full power there would be less energy available from the energy storage node 105A. In other words, if the power command 183A is for low power, then more energy can be obtained from the first energy storage node 105A. If the power command 183A is for high power, then less energy is available in the first energy storage node 105A because one battery cell may deplete quickly that has a very low SOC. If one battery cell has a very low SOC, the whole SOC can be zero for the first energy storage node 105A.

Proceeding now to block 415, the block 410 of dispatching the required power flow 112 across the plurality of energy storage nodes 105A-N can include executing a power command 183A to discharge the first energy storage node 105A-N based on the DC link balancing algorithm 190 being activated in response to the state of charge 116A being below the low SOC threshold 182 and calculating the first energy storage node 105A contains available stored power 184 to satisfy the power command 183A to discharge. The DC link balancing algorithm 190 can calculate the first energy storage node contains the available stored power 184 based on a DC link voltage 191 on a DC bus 225 of the first energy storage node 105A and a requested amount in the power command 183A to discharge.

Finishing now in block 420, the block 410 of dispatching the required power flow 112 across the plurality of energy storage nodes 105A-N can include executing a power command 183B to charge the first energy storage node 105A based on the DC link balancing algorithm 190 being activated in response to the state of charge 116A exceeding the high SOC threshold 181 and calculating the first energy storage node 105A contains sufficient power storage capacity 185 to satisfy the power command 183B to charge. The DC link balancing algorithm 190 can calculate the first energy storage node 105A contains sufficient power storage capacity 185 based on a DC link voltage 191 on a DC bus 225 of the first energy storage node 105A and the power command 183B to charge.

In FIG. 4A, the local control subsystem 110 can implement a subset or all of the blocks 405, 410, 415, and 420 of the adaptive dispatch protocol 400 without the central control system 115. For example, the required power flow 112 can be stored or received by one, a subset, or all of the control subsystem(s) 110 of the energy storage nodes 105A-N from the electrical application 103 over the network 305. The control subsystem 110 of the energy storage nodes 105A-N that receives the required power flow 112 can then implement blocks 410, 415, and 420.

In FIG. 4B, the core controllers 171A-N, node controllers 172A-N, and enclosure controllers 173A-N can implement a subset or all of the blocks 405, 410, 415, and 420 of the adaptive dispatch protocol 400 without the central array controller 170. For example, the required power flow 112 can be stored or received by one, a subset, or all of the core controllers 171A-N, node controllers 172A-N of the energy storage nodes 105A-N, and enclosure controllers 173A-N from the electrical application 103 over the network 305. The adaptive dispatch programming 330A may be stored and executed on the core controllers 171A-N and enclosure controllers 173A-N.

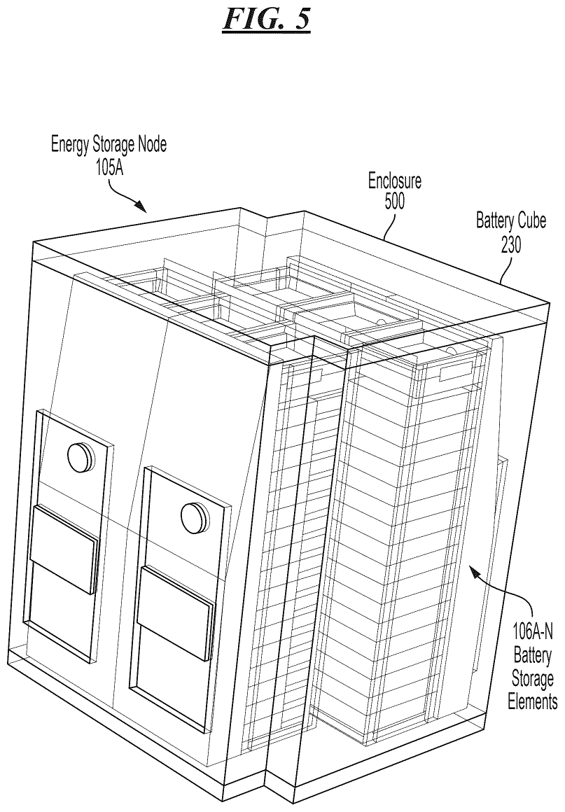

FIG. 5 is a cutaway view of the first energy storage node 105A of the plurality of energy storage nodes 105A-N and shows details of a plurality of battery storage elements 106A-N. As shown, the energy storage node 105A includes an enclosure 500, such as a physical housing to store a plurality of battery storage elements 106A-N. The battery storage elements 106A-N can be a collection of one or more batteries, such as a plurality of battery strings or battery banks, which are organized logically, physically, and electrically.

In the example of FIG. 5, the battery storage elements 106A-N can include battery racks (e.g., six are shown) that hold a respective stack of battery modules (e.g., seventeen are shown). The battery modules can include an array of prismatic, pouch, or cylindrical battery cells that are packaged together to increase voltage, amperage, or both. In some examples, battery modules may include an electric vehicle battery pack, e.g., a collection of lithium-ion battery cells that are packaged together.

Each of the energy storage nodes 105A-N can include a collection of one or more enclosures 500A-N like that shown in FIG. 5 that house a plurality of battery storage elements 106A-N packaged together as a battery cube 230 in the example. Of course, the enclosure 500 can be shaped in a variety of other form factors. Each of the battery cubes 230A-N can further include a respective enclosure controller 173A-N that is controlled by a respective node controller 172A-N as part of the control system 115.

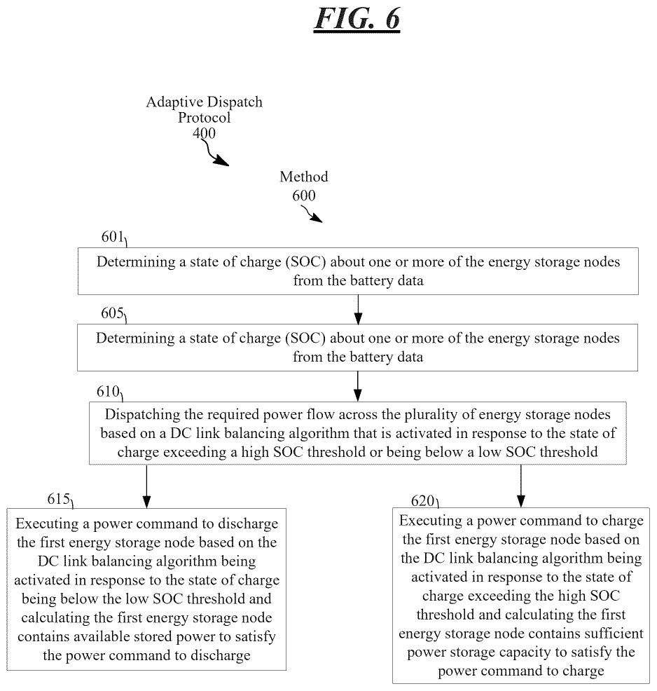

FIG. 6 is a flowchart of a method 600 that can be implemented for adaptive dispatch of the energy storage system 100. In the example of FIG. 6, the method 600 implements the adaptive dispatch protocol 400 of FIG. 4. Beginning in step 601, the method 600 includes receiving or storing a required power flow 112 for an electrical application 103.

Continuing to step 605, the method 600 further includes determining a state of charge (SOC) 116A about one or more of the energy storage nodes 105A-N from the battery data 111A-N. The state of charge 116A can be determined for a first energy storage node 105A that includes a plurality of battery cubes 230A-N and the control subsystem 110 includes at least one battery management system (BMS).

Proceeding now to step 610, the method 600 further includes dispatching the required power flow 112 across the plurality of energy storage nodes 105A-N based on a DC link balancing algorithm 190 that is activated in response to the state of charge 116A exceeding a high SOC threshold 181 or being below a low SOC threshold 182.

Referring to FIG. 7, in the depicted A2 bands, the BMS provided SOC 116A will be disregarded. Instead, the DC link voltage balancing algorithm 190 is activated by the adaptive dispatch programming 330A-B. The DC link voltage balancing algorithm 190 is based on a reading of the DC link voltage 191on the DC bus 225 and the power command 183A-B. Based on the DC link voltage balancing algorithm 190, the adaptive dispatch programming 330A-B can continue to dispatch a first energy storage node 105A even though the SOC 116A might indicate zero. Conventional control systems do not dispatch when the SOC 116A is zero. With the DC link balancing algorithm 190, energy is not left on the table when the SOC 116A of a first energy storage node 105A is near empty in the first A2 band, and even when the SOC is 100% in the second A2 band, the DC link balancing algorithm 190 may charge the first energy storage node 105A a bit more.

Moving now to step 615 of method 600, the step 610 of dispatching the required power flow 112 across the plurality of energy storage nodes 105A-N can include executing a power command 183A to discharge the first energy storage node 105A-N based on the DC link balancing algorithm 190 being activated in response to the state of charge 116A being below the low SOC threshold 182 and calculating the first energy storage node 105A contains available stored power 184 to satisfy the power command 183A to discharge. The DC link balancing algorithm 190 can calculate the first energy storage node 105A contains the available stored power 184 based on a DC link voltage 191 on a DC bus 225 of the first energy storage node 105A and a requested amount in the power command 183A to discharge.

Finishing now in step 620 of method 600, the step 610 of dispatching the required power flow 112 across the plurality of energy storage nodes 105A-N can include executing a power command 183B to charge the first energy storage node 105A based on the DC link balancing algorithm 190 being activated in response to the state of charge 116A exceeding the high SOC threshold 181 and calculating the first energy storage node 105A contains sufficient power storage capacity 185 to satisfy the power command 183B to charge. The DC link balancing algorithm 190 can calculate the first energy storage node 105A contains sufficient power storage capacity 185 based on a DC link voltage 191 on a DC bus 225 of the first energy storage node 105A and the power command 183B to charge.

FIG. 7 is a graph of two curves of the DC link voltage 191 and state of charge 116A showing two A2 areas (e.g., regions) in which the DC link balancing algorithm 190 is activated by the adaptive dispatch programming 330A-B. The DC link voltage 191 is of all batteries on the DC bus 225 for an energy storage node 105. In region A1, the adaptive dispatch programming 330A-B does not activate the DC link balancing algorithm 190. The dashed line is of the open circuit voltage 720 and the solid line is of the voltage under load 725.

The adaptive dispatch programming 330A-B is a balancing method that divides an SOC voltage curve 700 into two parts, A1 and A2. A1 is the area where SOC estimation may not corollate with the voltage, as the SOC estimation is relatively independent from the voltage. In this area A1, SOC estimation is the best feedback to balance the SOC, and as a result, balance DC link voltages 191 of the energy storage nodes 105A-N. Two A2 areas are the areas where SOC estimation may have relatively larger errors. However, in areas A2, SOC 116A and DC link voltage 191 corollate very well; therefore, DC link voltage 191 in areas A2 is the best feedback to be used for SOC and node voltage balancing. Areas A1 and A2 are distinguished by two SOC_{H} and SOC_{L}. However, the SOC voltage curve 700 may move based on the load, and can vary from one battery to another. Therefore, SOC_{H} and SOC_{L} are estimated borders for areas A1 and A2s. An additional control is developed to ensure DC link balancing if area A1 is the active area for balancing, but the batteries are in area A2.

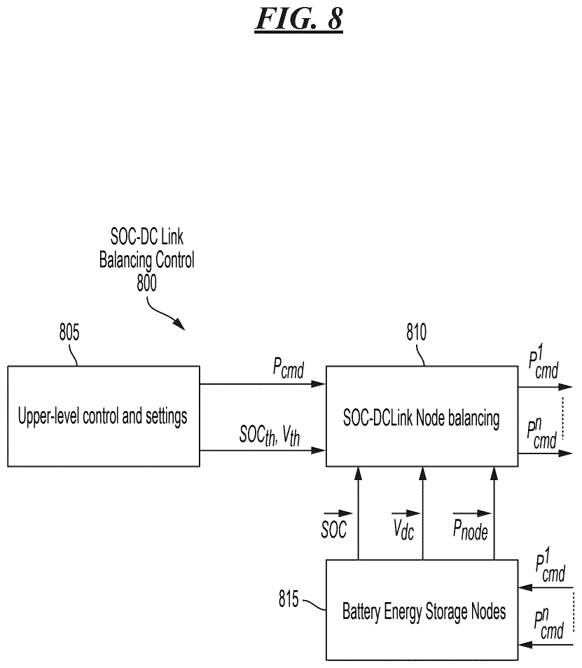

FIG. 8 is a block diagram of an SOC-DC link balancing control 800 of adaptive dispatch programming 330A-B showing the DC link balancing algorithm 190. In block 805, an upper level control of the adaptive dispatch programming 330A-B sends the total power command P_{cmd} and settings such as SOC_{H}, SOC_{L} and Vₜₕ to the SOC-DCLink balancing control of block 810. SOC_{H} is the high SOC to enter area A2 and SOC_{L} is the low SOC to enter area A2. Vₜₕ is the threshold voltage 192 of the voltage difference between DC links of energy storage nodes 110A-N; this voltage triggers tripping in the power conversion systems 104A-N of energy nodes 105A-N. As FIG. 8 shows, the balancing control block also receives the following sensing information from nodes: state of charge of nodes \vec{SOC} 116A, DC link voltage of nodes \vec{V_{dc}} 191, and power of nodes \vec{P_{node}}. In block 810, the SOC_DCLink energy storage node balancing block generates the control power commands Pⁱ_{cmd} which are received by the battery energy storage nodes 105A-N in block 815.

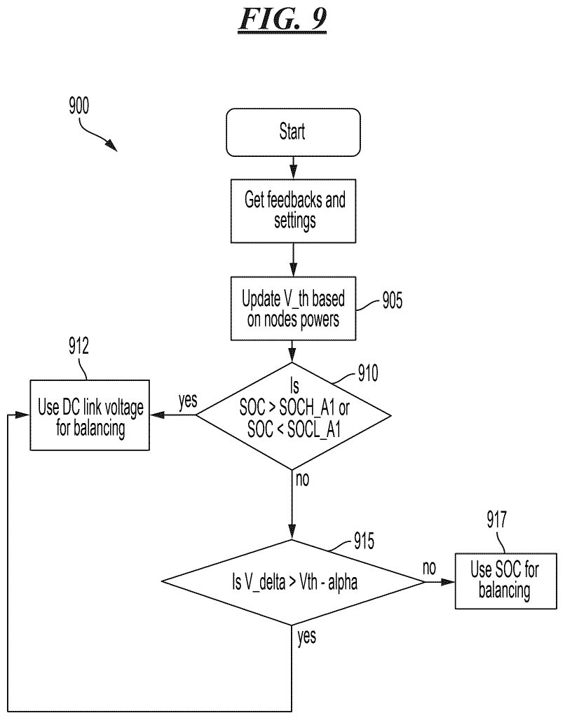

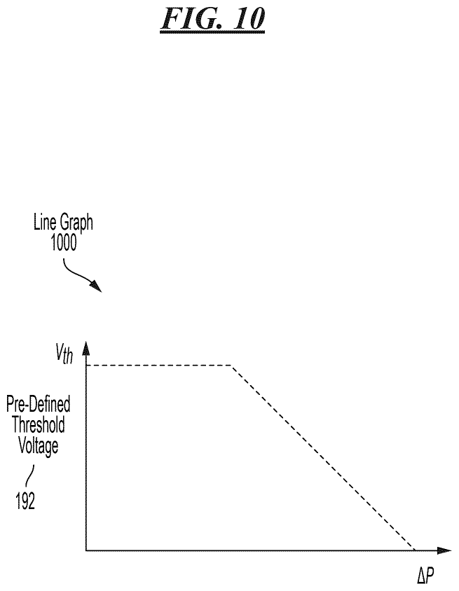

FIG. 9 is a flowchart 900 of the DC link balancing control algorithm 190 of the adaptive dispatch programming 330A-B. FIG. 10 is a line graph 1000 of an example relationship between a threshold voltage 192 (Vₜₕ) and ΔP_{nodes} showing an example relationship between Vₜₕ and ΔP_{nodes}. The control system 115, including the array controller 170, can be configured to dispatch the required power flow 112 across the plurality of energy storage nodes 105A-N based on the DC link balancing algorithm 190 being further activated based on a DC link voltage 191 between the energy storage nodes 105A-N diverging over a pre-defined threshold voltage 192. For example, the adaptive dispatching programming 330A-B looks at outlier battery cells. When looking at the battery cell level in each of the battery cubes 230A-B, the battery cells are rarely perfectly matched at the exact same voltage. As long as the delta between the battery cells is greater than standard delta (pre-defined threshold voltage 192), regular SOC 116 balancing can be used. But if there is an imbalance such that the difference between high cell and low cell is greater than the pre-defined voltage threshold 192, then the DC link balancing algorithm 190 is activated.

Referring to FIG. 9, in step 905, the DC link balancing control algorithm 190 of the adaptive dispatch programming 330A-B first calls on a function to update threshold voltage Vₜₕ, as this voltage value can be dependent on other parameters. In the example used here, Vₜₕ is dependent on the power difference between nodes ΔP_{nodes}=max(Pᵢ−Pᵢ₊₁).

In step 910, the DC link balancing control algorithm 190 determines which area is active based on the settings SOC_{H}, SOC_{L} and Vₜₕ. The greater than and less than are the A2 sections shown in FIG. 7. Less than A1 and greater than A1 is in the A2 regions at the high SOC threshold 181 and low SOC threshold 182. In those regions, the adaptive dispatch programming 330A-B can use its own SOC value not the BMS provided value for SOC 116A as shown in step 91. When the SOC is greater than SOCH_A1 is the A2 circle at the top of FIG. 7 and less than SOCL_A1 is the A2 circle at the bottom of FIG. 7. These two A2 regions are where the DC link balancing algorithm 190 calculation is utilized instead of the SOC 116A reported by the BMS.

Moving to step 915, V_delta is defined as maximum voltage difference between nodes, ΔV_{nodes}=max(Vᵢ−Vᵢ₊₁). If ΔV_{nodes}>Vₜₕ−α was true, then the DC link voltage 191 can be the feedback for the balancing controller and step 912 is executed. Alpha a is a tolerate to account for sensing errors and response speed. If ΔV_{nodes}>Vₜₕ−α was not true, then SOC_{H} and SOC_{L} will be used to determine the correct area and feedback for the DC link balancing control algorithm 190 in step 917.

The DC link balancing control algorithm 190 is an adaptive proportional controller where the power of proportional control is adapted by the error e=max(fᵢ−fᵢ₊₁) where f is the selected feedback, V_{dc} or SOC of energy storage nodes 105A-N. The maximum difference between SOCs 116A or DC link voltages 191 are defined as the error. The goal of the balancing controller is to drive this error to zero. The control law is defined as follows:

$${P}_{cmd}^{i} = {P}_{cmd} * {f}^{n} / \sum {f}^{n} \qquad ( 1 )$$

where n is adaptive to the magnitude of e. For example, n can be a linear function as follows:

$$n = Ψ ( e ) \qquad ( 2 )$$

A linear rising function Y′ will allow to control the speed of the balancing controller based on the magnitude of the error. This will ensure a smooth balancing of energy storage nodes 105A-N as their SOC 116A or DC link voltages 191 vary due to various physical and computational reasons.

In the examples above, the energy system 102, energy application 103, power conversion system 104, energy storage nodes 105A-N, control subsystem 110, control system 115, array controller 170, core controllers 171A-N, node controllers 172A-N, enclosure controllers 173A-N, etc. each include a network communication interface 311, 351 for wired or wireless communication over one or more networks 305A-N. The networks 305A-N interconnect the links to/from the network communication interfaces 311, 351 of the devices, so as to provide data communications amongst the energy application 103, energy storage nodes 105A-N, control system 115, array controller 170, core controllers 171A-N, node controllers 172A-N, enclosure controllers 173A-N, etc. Networks 305A-N may support data communication by equipment at the premises via wired (e.g., cable or fiber) media or via wireless (e.g., Wi-Fi, Bluetooth™, ZigBee, LiFi, IrDA, etc.) or combinations of wired and wireless technology.

Any of the functionality of the adaptive dispatch protocol 400, including adaptive dispatch programming 330A-B and DC link balancing algorithm 190, described herein for the energy system 102, electrical application 103, power conversion system 104, energy storage nodes 105A-N, control subsystem 110, control system 115, array controller 170, core controllers 171A-N, node controllers 172A-N, enclosure controllers 173A-N, etc. can be embodied in one more applications or firmware as described previously. According to some embodiments, “function,” “functions,” “application,” “applications,” “instruction,” “instructions,” or “programming” are program(s) that execute functions defined in the programs. Various programming languages can be employed to create one or more of the applications, structured in a variety of manners, such as object-oriented programming languages (e.g., Objective-C, Java, or C++) or procedural programming languages (e.g., C or assembly language).

In the examples above, the energy system 102, energy application 103, power conversion system 104, energy storage nodes 105A-N, control subsystem 110, control system 115, array controller 170, core controllers 171A-N, node controllers 172A-N, enclosure controllers 173A-N, etc. can each include a processor. As used herein, a processor 312, 352 is a hardware circuit having elements structured and arranged to perform one or more processing functions, typically various data processing functions. Although discrete logic components could be used, the examples utilize components forming a programmable central processing unit (CPU). A processor 312, 352 for example includes or is part of one or more integrated circuit (IC) chips incorporating the electronic elements to perform the functions of the CPU. The processors 312, 352 for example, may be based on any known or available microprocessor architecture, such as a Reduced Instruction Set Computing (RISC) using an ARM architecture. Of course, other processor circuitry may be used to form the CPU or processor hardware in. The illustrated examples of the processors 312, 352 can include one microprocessor or a multi-processor architecture. A digital signal processor (DSP) or field-programmable gate array (FPGA) could be suitable replacements for the processors 312, 352, but may consume more power with added complexity.

The applicable processor 312, 352 executes programming or instructions to configure the energy system 102, energy application 103, power conversion system 104, energy storage nodes 105A-N, control subsystem 110, control system 115, array controller 170, core controllers 171A-N, node controllers 172A-N, enclosure controllers 173A-N, etc. to perform various operations. For example, such operations may include various general operations (e.g., a clock function, recording and logging operational status and/or failure information) as well as various system-specific operations (e.g., energy management) functions. Although a processor 312, 352 may be configured by use of hardwired logic, typical processors are general processing circuits configured by execution of programming, e.g., instructions and any associated setting data from the memories 313, 353 shown or from other included storage media and/or received from remote storage media.

In the examples above, the energy system 102, energy application 103, power conversion system 104, energy storage nodes 105A-N, control subsystem 110, control system 115, array controller 170, core controllers 171A-N, node controllers 172A-N, enclosure controllers 173A-N, etc. each include a memory. The memory 313, 353 may include a flash memory (non-volatile or persistent storage), a read-only memory (ROM), and a random access memory (RAM) (volatile storage). The RAM serves as short term storage for instructions and data being handled by the processors 312, 352 e.g., as a working data processing memory. The flash memory typically provides longer term storage.

Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

Hence, a machine-readable medium or a computer-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

According to exemplary embodiments of the present disclosure the one or more processors and control circuits can include one or more of any known general purpose processor or integrated circuit such as a central processing unit (CPU), microprocessor, field programmable gate array (FPGA), Application Specific Integrated Circuit (ASIC), Digital Signal Processor (DSP), or other suitable programmable processing or computing device or circuit as desired that is specially programmed to perform operations for achieving the results of the exemplar embodiments described herein. The processor(s) can be configured to include and perform features of the exemplary embodiments of the present disclosure, such as the adaptive dispatch protocol 400, the adaptive dispatch programming 330A-B, and the DC link balancing algorithm 190. The features can be performed through program code encoded or recorded on the processor(s), or stored in a non-volatile memory device, such as Read-Only Memory (ROM), erasable programmable read-only memory (EPROM), or other suitable memory device or circuit as desired. Accordingly, such computer programs can represent controllers of the computing device.

In another exemplary embodiment, the program code, such as the adaptive dispatch protocol 400, the adaptive dispatch programming 330A-B, and the DC link balancing algorithm 190 can be provided in a computer program product having a non-transitory computer readable medium, such as Magnetic Storage Media (e.g. hard disks, floppy discs, or magnetic tape), optical media (e.g., any type of compact disc (CD), or any type of digital video disc (DVD), or other compatible non-volatile memory device as desired) and downloaded to the processor(s) for execution as desired, when the non-transitory computer readable medium is placed in communicable contact with the processor(s).

The one or more processors 312, 352 can be included in a computing system that is configured with components such as memory, a hard drive, an input/output (I/O) interface, a communication interface, a display and any other suitable component as desired. The exemplary computing device can also include a communications interface. The communications interface can be configured to allow software and data to be transferred between the computing device and external devices. Exemplary communications interfaces can include a modem, a network interface (e.g., an Ethernet card), a communications port, a PCMCIA slot and card, or any other suitable network communication interface as desired. Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, or any other suitable communication link as desired.

Where the present disclosure is implemented using programming or software, including the adaptive dispatch protocol 400 and the adaptive dispatch programming 330A-B, the programming or software can be stored in a computer program product or non-transitory computer readable medium and loaded into the computing device using a removable storage drive or communications interface. In an exemplary embodiment, any computing device, such as control subsystem 110, control system 115 and controllers 170-173, disclosed herein can also include a display interface that outputs display signals to a display unit, e.g., LCD screen, plasma screen, LED screen, DLP screen, CRT screen, or any other suitable graphical interface as desired.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” “has,” “having,” “containing,” “contain”, “contains,” “with,” “formed of,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element. Unless otherwise stated, the articles “a” or “an” preceding an element mean one or more of the elements.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±5% or as much as ±10% from the stated amount. The terms “approximately” and “substantially” mean that the parameter value or the like varies up to ±10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

What is claimed is:

1. An energy storage system, comprising:
a plurality of energy storage nodes, wherein the plurality of energy storage nodes include:
a battery storage element, and
a control subsystem to receive battery data from the battery storage element;
a power conversion system (PCS); and
a control system coupled to the plurality of energy storage nodes and configured to receive or store a required power flow;
wherein:
the control subsystem, the control system, or both are configured to determine a state of charge (SOC) about one or more of the energy storage nodes from the battery data; and
the control system is configured to dispatch the required power flow across the plurality of energy storage nodes based on a DC link balancing algorithm that is activated in response to the state of charge exceeding a high SOC threshold or being below a low SOC threshold.

2. The energy storage system of claim 1, wherein the state of charge is determined for a first energy storage node that includes a plurality of battery cubes and the control subsystem includes at least one battery management system (BMS).

3. The energy storage system of claim 2, wherein the dispatching the required power flow across the plurality of energy storage nodes includes executing a power command to discharge the first energy storage node based on the DC link balancing algorithm being activated in response to the state of charge being below the low SOC threshold and calculating the first energy storage node contains available stored power to satisfy the power command to discharge.

4. The energy storage system of claim 3, wherein the DC link balancing algorithm calculates the first energy storage node contains the available stored power based on a DC link voltage on a DC bus of the first energy storage node and requested amount in the power command to discharge.

5. The energy storage system of claim 2, wherein the dispatching the required power flow across the plurality of energy storage nodes includes executing a power command to charge the first energy storage node based on the DC link balancing algorithm being activated in response to the state of charge exceeding the high SOC threshold and calculating the first energy storage node contains sufficient power storage capacity to satisfy the power command to charge.

6. The energy storage system of claim 5, wherein the DC link balancing algorithm calculates the first energy storage node contains sufficient power storage capacity based on a DC link voltage on a DC bus of the first energy storage node and the power command to charge.

7. The energy storage system of claim 1, wherein the control system is configured to dispatch the required power flow across the plurality of energy storage nodes based on the DC link balancing algorithm being further activated based on a DC link voltage between the energy storage nodes diverging over a pre-defined threshold voltage.

8. A non-transitory computer-readable medium, comprising adaptive dispatch programming, wherein execution of the adaptive dispatch programming by one or more processors configures one or more controllers to:
receive or store a required power flow for an electrical application;
determine a state of charge (SOC) about one or more of the energy storage nodes from the battery data; and
dispatch the required power flow across the plurality of energy storage nodes based on a DC link balancing algorithm that is activated in response to the state of charge exceeding a high SOC threshold or being below a low SOC threshold.

9. The non-transitory computer-readable medium of claim 8, wherein the state of charge is determined for a first energy storage node that includes a plurality of battery cubes and the control subsystem includes at least one battery management system (BMS).

10. The non-transitory computer-readable medium of claim 9, wherein the dispatching the required power flow across the plurality of energy storage nodes includes executing a power command to discharge the first energy storage node based on the DC link balancing algorithm being activated in response to the state of charge being below the low SOC threshold and calculating the first energy storage node contains available stored power to satisfy the power command to discharge.

11. The non-transitory computer-readable medium of claim 10, wherein the DC link balancing algorithm calculates the first energy storage node contains the available stored power based on a DC link voltage on a DC bus of the first energy storage node and a requested amount in the power command to discharge.

12. The non-transitory computer-readable medium of claim 9, wherein the dispatching the required power flow across the plurality of energy storage nodes includes executing a power command to charge the first energy storage node based on the DC link balancing algorithm being activated in response to the state of charge exceeding the high SOC threshold and calculating the first energy storage node contains sufficient power storage capacity to satisfy the power command to charge.

13. The non-transitory computer-readable medium of claim 12, wherein the DC link balancing algorithm calculates the first energy storage node contains sufficient power storage capacity based on a DC link voltage on a DC bus of the first energy storage node and the power command to charge.

14. The non-transitory computer-readable medium of claim 8, wherein the control system is configured to dispatch the required power flow across the plurality of energy storage nodes based on the DC link balancing algorithm being further activated based on a DC link voltage between the energy storage nodes diverging over a pre-defined threshold voltage.

15. A method, comprising:
receiving or storing a required power flow for an electrical application;
determining a state of charge (SOC) about one or more of the energy storage nodes from the battery data; and
dispatching the required power flow across the plurality of energy storage nodes based on a DC link balancing algorithm that is activated in response to the state of charge exceeding a high SOC threshold or being below a low SOC threshold.

16. The method of claim 15, wherein the state of charge is determined for a first energy storage node that includes a plurality of battery cubes and the control subsystem includes at least one battery management system (BMS).

17. The method of claim 16, wherein the dispatching the required power flow across the plurality of energy storage nodes includes executing a power command to discharge the first energy storage node based on the DC link balancing algorithm being activated in response to the state of charge being below the low SOC threshold and calculating the first energy storage node contains available stored power to satisfy the power command to discharge.

18. The method of claim 17, wherein the DC link balancing algorithm calculates the first energy storage node contains the available stored power based on a DC link voltage on a DC bus of the first energy storage node and a requested amount in the power command to discharge.

19. The method of claim 16, wherein the dispatching the required power flow across the plurality of energy storage nodes includes executing a power command to charge the first energy storage node based on the DC link balancing algorithm being activated in response to the state of charge exceeding the high SOC threshold and calculating the first energy storage node contains sufficient power storage capacity to satisfy the power command to charge.

20. The method of claim 19, wherein the DC link balancing algorithm calculates the first energy storage node contains sufficient power storage capacity based on a DC link voltage on a DC bus of the first energy storage node and the power command to charge.
